(19) United States
(12) Patent Application Publication
(10) Pub. No.: US 2026/0336898 A1
(43) Pub. Date: Oct. 29, 2026

(54) LIQUID-DISPENSING TAP ARRANGEMENT

(71) Applicant: CONRO PRECISION PTY LTD, Cape Town (ZA)

(72) Inventor: Mark ROOS, Cape Town (ZA)

(21) Appl. No.: 18/730,843

(22) PCT Filed: Dec. 12, 2023
(86) PCT No.: PCT/IB2023/062532

§ 371 Date: Jul. 22, 2024

(51) Int. Cl. B65D 77/06; B65D 41/32

(52) U.S. Cl. CPC B65D 77/067; B65D 41/32; B65D 2401/15

(57) ABSTRACT

The invention discloses a liquid-dispensing tap arrangement with an automatic opening having tamper preventing means, which includes a body; an internal valve or membrane with elastic dome contained in the body; a driving element contained in and operatively coupled with the valve or membrane; a cap, which is stably constrained with the body forming a single component which cannot be divided, the cap being further operatively coupled with the driving element; a tamper-preventing ring element integrally formed with the cap; wherein the driving element is designed to be driven by the cap to allow opening and simultaneously breaking the tamper-preventing ring element from the cap; wherein the tamper-preventing ring element includes locking means adapted to lock the tamper-preventing ring element to the body once the tamper-preventing ring element is disconnected from the cap thereby preventing removal of the tamper-preventing ring element from the liquid dispensing tap arrangement.

### FIELD OF INVENTION

The present invention relates to a liquid-dispensing tap arrangement.

More particularly, the present invention relates to a liquid-dispensing tap arrangement for bag-in-box containers and having a tamper evident cap.

### BACKGROUND TO INVENTION

Various liquid dispensing taps for bag-in-box beverages such as wines are known. For example, WO2006051569A1 discloses a tap for dispensing liquids from a vessel, comprising: an elongated cylindrical support body with fitting means with the vessel, closed with a plug, and laterally equipped with a liquid outlet opening; a control member for opening and closing actuatable through a thrust on wing-shaped projecting members; and a valve member operatively connected to the control member and equipped with a liquid passage opening.

The challenge posed to known liquid-dispensing taps are new European and International Directives on the articles of disposable plastic which require that all elements remain bound to the tap after its opening and does not disperse in the environment thus allowing for correct recycling and that it adapts itself to taps currently on the market. Thus new tap inventions in this field aim to eliminate tamper evident band of known taps which presently is removed and potentially dispersed in the environment.

As a first solution, EP 20816646 patent application discloses a tamper-preventing liquid-dispensing tap with an automatic opening, comprising a first body equipped with a removal-preventing and tamper-preventing element with sharped edge; an internal valve or membrane with elastic dome contained in the first body; a second driving element contained in and operatively coupled with the valve or membrane; and a cap equipped with integrated sealing elements which remain fastened to the cap, which is stably constrained with the first body forming a single component which cannot be divided, the cap being further operatively coupled with the second driving element; wherein the second driving element is designed to be driven by the cap to allow opening and simultaneously breaking the seal elements of the tap.

It is an object of the invention to suggest a novel liquid-dispensing tap arrangement.

### SUMMARY OF INVENTION

According to the invention, a liquid-dispensing tap arrangement with an automatic opening having tamper preventing means, includes
(a) a body;
(b) an internal valve or membrane with elastic dome contained in the body;
(c) a driving element contained in and operatively coupled with the valve or membrane;
(d) a cap, which is stably constrained with the body forming a single component which cannot be divided, the cap being further operatively coupled with the driving element;
(e) a tamper-preventing ring element integrally formed with the cap;
(f) wherein the driving element is designed to be driven by the cap to allow opening and simultaneously breaking the tamper-preventing ring element from the tap;
(g) wherein the tamper-preventing ring element includes locking means adapted to lock the tamper-preventing ring element to the cap once the tamper-preventing ring element is disconnected from the cap thereby preventing removal of the tamper-preventing ring element from the tap arrangement.

The arrangement may be a vertical pull tap.

The tamper-preventing ring element may be connected to the tap by means of connecting strips.

The tamper-preventing ring element may have a larger inner diameter than the cap.

The locking means may include at least two circumferential protrusions on the inside of the tamper-preventing ring element and being adapted to engage with at least one outer protrusion of the body.

The liquid-dispensing tap arrangement may be incorporated bag-in-box containers.

### BRIEF DESCRIPTION OF DRAWINGS

The invention will now be described by way of example with reference to the accompanying schematic drawings.

In the drawings there is shown in

FIG. 1: A first perspective view of a liquid-dispensing tap arrangement according to the invention;

FIG. 2: a top view of the liquid-dispensing tap arrangement as shown in FIG. 1;

FIG. 3: a sectional view of the liquid-dispensing tap arrangement as indicated by A-A in FIG. 2;

FIG. 4: a detail view of the liquid-dispensing tap arrangement as indicated by D in FIG. 3;

FIG. 5: a side view of the liquid-dispensing tap arrangement as shown in FIG. 1;

FIG. 6: a front view of the liquid-dispensing tap arrangement as shown in FIG. 1;

FIG. 7: A second perspective view of a liquid dispensing tap arrangement according to the invention with the tamper-preventing ring element broken-off the cap;

FIG. 8: a top view of the liquid-dispensing tap arrangement as shown in FIG. 7;

FIG. 9: a sectional view of the liquid-dispensing tap arrangement as indicated by B-B in FIG. 8;

FIG. 10: a detail view of the liquid-dispensing tap arrangement as indicated by C in FIG. 9;

FIG. 11: a side view of the liquid-dispensing tap arrangement as shown in FIG. 7;

FIG. 12: a front view of the liquid-dispensing tap arrangement as shown in FIG. 7;

FIG. 13: a top perspective view of the cap of the liquid-dispensing tap arrangement as shown in FIG. 1;

FIG. 14: a bottom perspective view of the cap of the liquid-dispensing tap arrangement as shown in FIG. 13;

FIG. 15: a bottom view of the cap of the liquid-dispensing tap arrangement as shown in FIG. 13;

FIG. 16: a top view of the cap of the liquid-dispensing tap arrangement as shown in FIG. 13

FIG. 17: a first side view together with a first sectional view A-A of the cap of the liquid dispensing arrangement as shown in FIG. 13; and

FIG. 18: a second side view together with a second sectional view B-B of the cap of the liquid dispensing arrangement as shown in FIG. 13

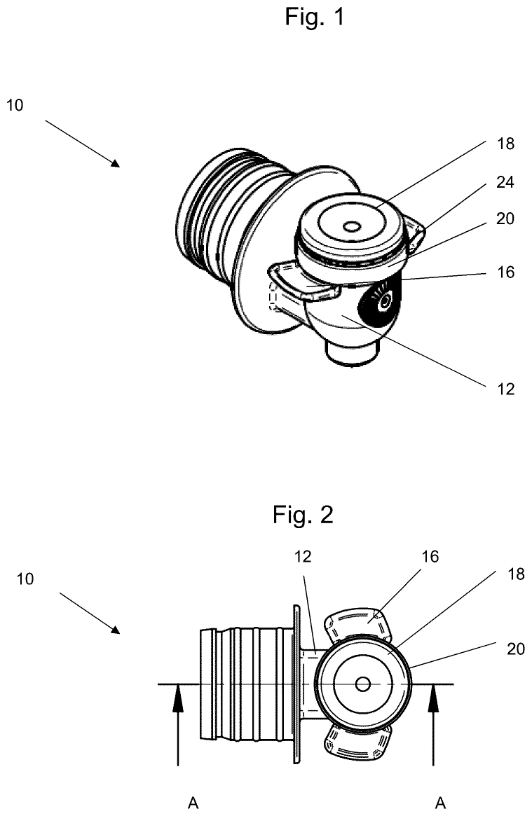

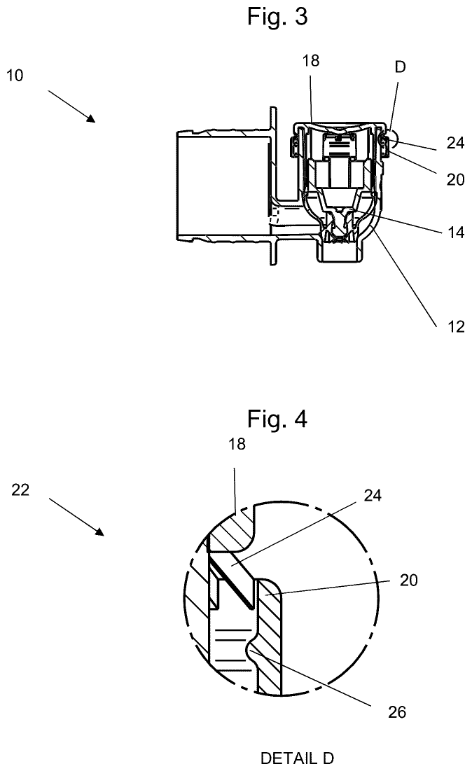

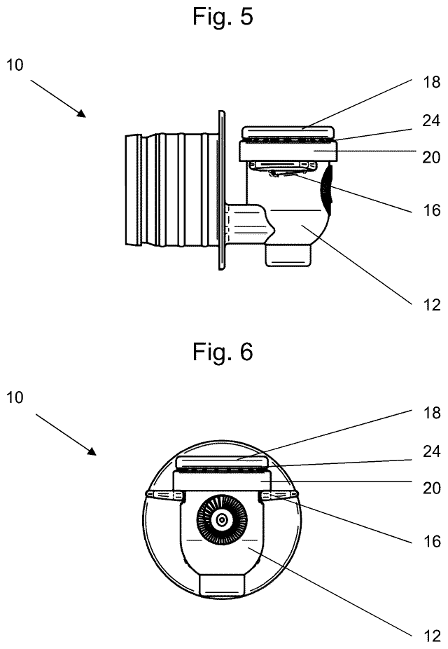

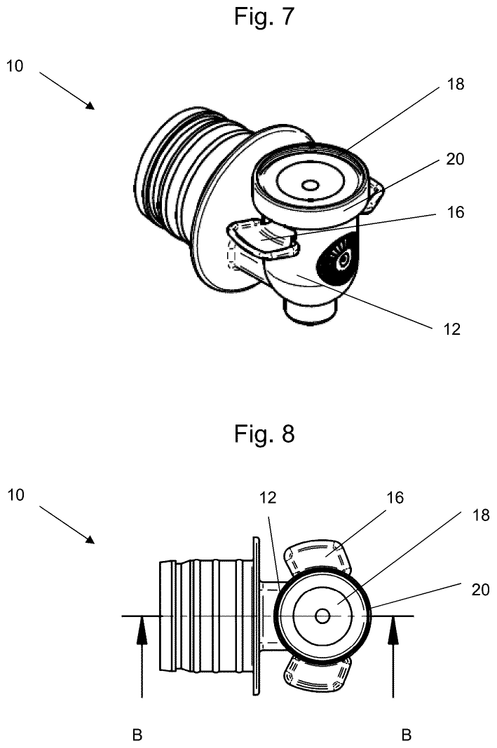

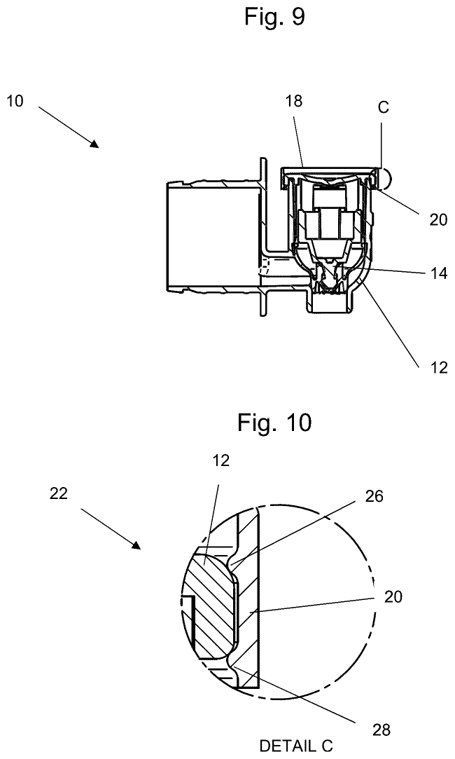

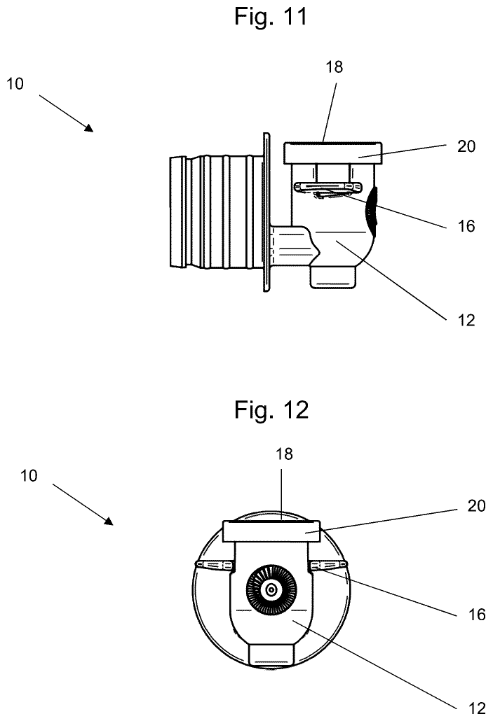

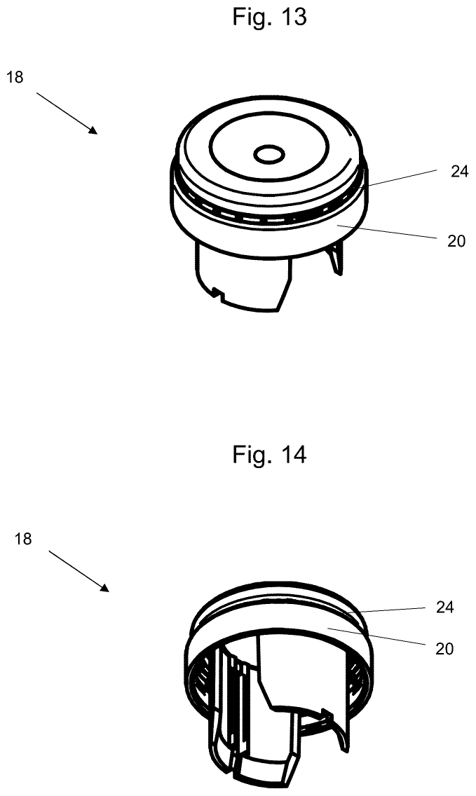

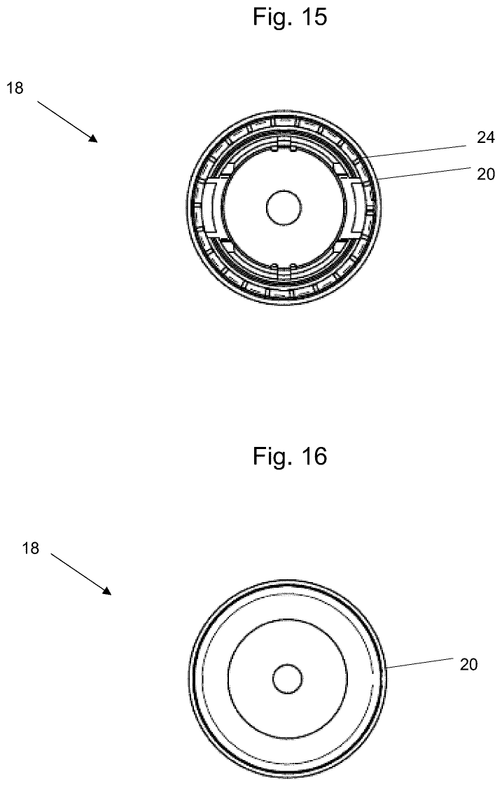

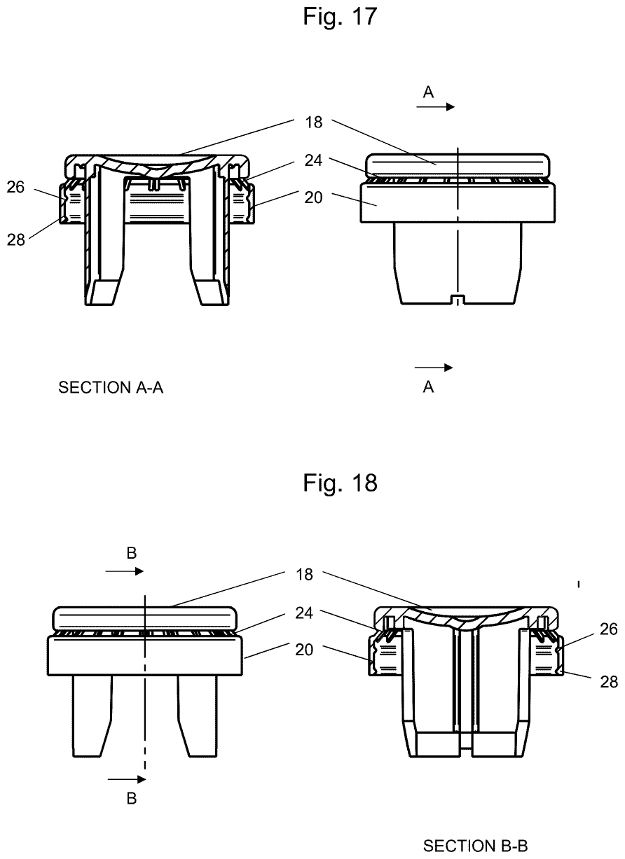

### DETAILED DESCRIPTION OF DRAWINGS

Referring to the drawings, there is shown a liquid-dispensing tap arrangement, generally indicated by reference numeral 10, in accordance with the invention.

According to the invention, a liquid-dispensing tap arrangement 10 with an automatic opening having tamper preventing means, includes
(a) a body 12;
(b) an internal valve or membrane with elastic dome 14 contained in the body 12;
(c) a driving element 16 contained in and operatively coupled with the valve or membrane 14;
(d) a cap 18, which is stably constrained with the body 12 forming a single component which cannot be divided, the cap 18 being further operatively coupled with the driving element 16;
(e) a tamper-preventing ring element 20 integrally formed with the cap 18;
(f) wherein the driving element 16 is designed to be driven by the cap 18 to allow opening and simultaneously breaking the tamper-preventing ring element 20 from the cap 18;
(g) wherein the tamper-preventing ring element 20 includes locking means 22 adapted to lock the tamper-preventing ring element 20 to the body 12 once the tamper-preventing ring element 20 is disconnected from the cap 18 thereby preventing removal of the tamper-preventing ring element 20 from the liquid dispensing tap arrangement 10.

The arrangement 10 can be a vertical pull tap.

The tamper-preventing ring element 20 is connected to the cap 18 by means of connecting strips 24.

The tamper-preventing ring element 20 has a larger inner diameter than the cap 18.

The locking means 22 includes at least two circumferential protrusions 26 and 28 on the inside of the tamper-preventing ring element 20 and being adapted to engage with at least one outer protrusion 30 of the body 12.

The liquid-dispensing tap arrangement 10 can be incorporated bag-in-box containers.

1. A liquid-dispensing tap arrangement with an automatic opening having tamper preventing means, which includes:
(a) a body;
(b) an internal valve or membrane with elastic dome contained in the body;
(c) a driving element-16 contained in and operatively coupled with the valve or membrane;
(d) a cap, which is stably constrained with the body forming a single component which cannot be divided, the cap being further operatively coupled with the driving element;
(e) a tamper-preventing ring element integrally formed with the cap;
(f) wherein the driving element is designed to be driven by the cap to allow opening and simultaneously breaking the tamper-preventing ring element from the cap;
(g) wherein the tamper-preventing ring element includes locking means adapted to lock the tamper-preventing ring element to the body once the tamper-preventing ring element is disconnected from the cap thereby preventing removal of the tamper-preventing ring element from the liquid dispensing tap arrangement.

2. The arrangement as claimed in claim 1, which is a vertical pull tap.

3. The arrangement as claimed in claim 1, in which the tamper-preventing ring element is connected to the cap by means of connecting strips.

4. The arrangement as claimed in claim 1, in which the tamper-preventing ring element has a larger inner diameter than the cap.

5. An The arrangement as claimed in claim 1, in which the locking means includes at least two circumferential protrusions and on the inside of the tamper-preventing ring element and being adapted to engage with at least one outer protrusion of the body.

6. The arrangement as claimed in claim 1, which is adapted to be incorporated into bag-in-box containers.

7. A bag-in-box container having a liquid-dispensing tap arrangement as claimed in claim 1.

8.-10. (canceled)
